(19) United States
(12) Patent Application Publication
(10) Pub. No.: US 2008/0154897 A1
(43) Pub. Date: Jun. 26, 2008

(54) Automated Interpretation and Replacement of Date References in Unstructured Text

(75) Inventors: Yetisgen Yildiz Meliha, Kenmore, WA (US); Radu Stefan Niculescu, Malvern, PA (US); Romer E. Rosales, Downingtown, PA (US); R. Bharat Rao, Berwyn, PA (US); Sriram Krishnan, Exton, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solution USA, Inc., Malvern, PA (US)

(21) Appl. No.: 11/942,127

(22) Filed: Nov. 19, 2007

Related U.S. Application Data
(60) Provisional application No. 60/860,204, filed on Nov. 20, 2006.

(51) Int. Cl. G06F 17/30

(52) U.S. Cl. 707/6; 707/E17.058

(57) ABSTRACT

A method for interpreting date information from unstructured text includes performing phrase tokenization on the unstructured text to identify one or more temporal phrases. Word categorization is performed on the one or more temporal phrases to categorize one or more words of each temporal phrase. Grammar analysis is performed to match each temporal phrase to an understood syntax using the categorizations of the words of each temporal phrase. Each temporal phrase is interpreted based on the matched syntax.

### CROSS-REFERENCE TO RELATED APPLICATION

The present application is based on provisional application Ser. No. 60/860,204, filed Nov. 20, 2006, the entire contents of which are herein incorporated by reference.

### BACKGROUND OF THE INVENTION

1. Technical Field

The present disclosure relates to date references and, more specifically, to automatic interpretation and replacement of date references in unstructured text.

2. Discussion of the Related Art

Computer-readable text may be either structured or unstructured. In structured text, such as XML text, each item of information may be appropriately tagged so that a computer may quickly and easily identify the type of information presented and know how that information is to be interpreted. By structuring text, ambiguity may be minimized and accuracy may be increased.

When dealing with date information, structured text may perform two functions. First, the pertinent portion of the text may be tagged as date information so that the computer may know it has encountered a date. Then, the date information may be presented according to an expected syntax such as [YYYY-MM-DD], where “YYY” represents a four-digit year, “MM” represents a two-digit month, and “DD” represents a two-digit date. The specific time of day may also be presented according to an expected syntax such as “HH:MM:SS” where “HH” represents the hour from 0 to 24, “MM” represents the minute from 0 to 60, and “SS” represents the second from 0 to 60.

Thus, when using structured text, a computer may be able to utilize date information in a desired way quickly and without ambiguity. However, in practice most user-created text information is not structured. When text originates as hand-written instructions and is later converted to digital text either by optical character recognition or transcription, it might not be clear when text information represents a date or time. This may also be true of text that originates in digital form where a user inputs a time or date as part of a general text field that is not a specialized date field.

One common example is a medical record. Medical records are commonly hand-written and may later be scanned or transcribed. However even when medical records are inputted directly into a computer, either as they are written or when being transcribed, there may be portions of the record form that are text fields where the medical practitioner is expected to record freeform information pertaining to the patient and possible courses of treatment. This may be true even when the form includes a specialized date field. For example, one form field may be dedicated to the patient's date of birth and another form field may be dedicated to the date of examination. Such data may be considered structured data. However, in a text field provided for the practitioner to enter freeform information, for example, a diagnosis, times and dates may be included. This data may be considered unstructured data.

Unstructured data presents a particular problem for computer applications as the computer may not be aware of the existence of a time or date within the freeform unstructured text. This may not be a problem when dealing with a particular patient as the relevant medical records may be quickly read through, however, when research is performed using medical records, researchers must be able to quickly search through a great many medical records to identify certain date related characteristics such as the length of time since the patient has quit smoking or the length of time the patient has experienced a particular symptom. These data characteristics may be buried within the unstructured freeform information of the medical records.

Accordingly, before unstructured time and date information may be effectively utilized by a computer application, the unstructured text may be interpreted. Interpretation of unstructured text may involve recognition of date information as usable, searchable data.

Thus there is a need for the interpretation of time and date information from within unstructured text. However, time and date information may be presented either simply or complexly. For example, text including the phrase, “Jan. 1, 2006” may be recognized as [2006-01-01]. However, in practice, time and date information may be substantially more complex. For example, text may include the phrase, “The patient presents complaining of severe pain starting approximately two weeks ago.” In such a case, existing computer applications may not be capable of interpreting the date information embodied in the unstructured text and this information would have to be interpreted by a human reviewer. This manual review may be time consuming, especially where there are thousands of medical records to review as is often the case for medical research.

### SUMMARY

A method for interpreting date information from unstructured text includes performing phrase tokenization on the unstructured text to identify one or more temporal phrases. Word categorization is performed on the one or more temporal phrases to categorize one or more words of each temporal phrase. Grammar analysis is performed to match each temporal phrase to an understood syntax using the categorizations of the words of each temporal phrase. Each temporal phrase is interpreted based on the matched syntax.

Interpreting each temporal phrase may produce structured date information and the structured date information may be associated with the respective temporal phrase. The associated structured date information may be saved to the unstructured text as metadata.

Interpretation of one or more temporal phrases may be made with reference to structured date information. The structured date information may be time stamp information. The structured date information may be read from a first field of a database record and the unstructured text may be included in a second field of the database record.

Performing phrase tokenization on the unstructured text to identify one or more temporal phrases may include comparing one or more words of the unstructured text to a library of words or phrases known to be commonly used in expressing date information. The library of words or phrases known to be commonly used in expressing date information may include context-relevant words or phrases. The date information may include one or more of a year, month, week, day, hour, minute or second.

Performing word categorization on the one or more temporal phrases may include determining whether one or more words of the temporal phrases conforms to one or more of a set of predefined categories.

In performing grammar analysis to match each temporal phrase to an understood syntax using the categorizations of the words of each temporal phrase, the matching of the words of each phrase may include comparing each phrase to a set of rules to determine the particular phrase structure employed.

A system for interpreting date information from unstructured text includes a database for storing one or more records having an unstructured text field including unstructured text. A phrase tokenization unit performs phrase tokenization on the unstructured text to identify one or more temporal phrases. A word categorization unit performs word categorization on the one or more temporal phrases to categorize one or more words of each temporal phrase. A grammar analysis unit performs grammar analysis to match each temporal phrase to an understood syntax using the categorizations of the words of each temporal phrase.

An association unit may associate structured date information, produced by interpreting each temporal phrase, with the respective temporal phrase.

Interpretation of one or more temporal phrases may be made with reference to structured date information from a structured date field within the record. The structured date information may be a time stamp.

A computer system includes a processor and a program storage device readable by the computer system, embodying a program of instructions executable by the processor to perform method steps for interpreting date information from unstructured text. The method includes receiving a record from a database, the record including an unstructured text field including the unstructured text. Phrase tokenization is performed on the unstructured text to identify one or more temporal phrases. Word categorization is performed on the one or more temporal phrases to categorize one or more words of each temporal phrase. Grammar analysis is performed to match each temporal phrase to an understood syntax using the categorizations of the words of each temporal phrase. Each temporal phrase is interpreted based on the matched syntax to produce structured date information. The structured date information is written to the database record.

The associated structured date information may be saved to the unstructured text as metadata. Interpretation of one or more temporal phrases may be made with reference to timestamp date information associated with the record. Performing phrase tokenization on the unstructured text to identify one or more temporal phrases may include comparing one or more words of the unstructured text to a library of words or phrases known to be commonly used in expressing date information.

In performing grammar analysis to match each temporal phrase to an understood syntax using the categorizations of the words of each temporal phrase, the matching of the words of each phrase may include comparing each phrase to a set of rules to determine the particular phrase structure employed.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a diagram showing an exemplary record including both structured fields and unstructured text fields;

FIG. 2 is a flow chart showing a method for identification of unstructured text according to an exemplary embodiment of the present invention; and

FIG. 3 shows an example of a computer system which may implement a method and system of the present disclosure.

### DETAILED DESCRIPTION OF THE DRAWINGS

In describing the exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention seek to perform automated interpretation of time and date information within unstructured text, even when the time and date information is written in a complex manner. Time and date information may thus be interpreted, for example, in light of known dates that may appear within structured fields.

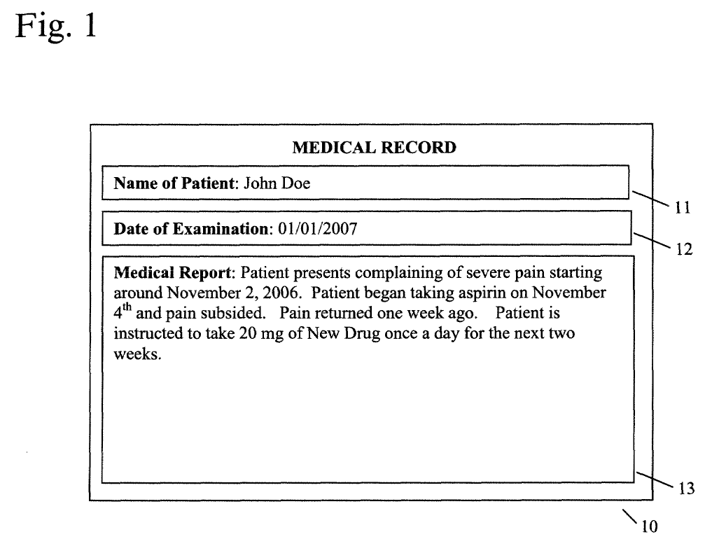

FIG. 1 is a diagram showing an exemplary record including both structured fields and unstructured text fields. The medical record 10 may be a database record that has either been transcribed from a written record or has been scanned and recognized using optical character recognition (OCR). The medical record 10 may include a “Name of Patient” field 11, a “Date of Examination” field, and a “Medical Report” field. The “Date of Examination” field 12 may be a structured date field where date information is recorded according to the syntax [MM/DD/YYYY]. The “Name of Patient” field 11 and the “Medical Report” field 13 may be unstructured text field that may include one or more instances of time and/or date information. This exemplary record 10 is offered as an example of a record including unstructured text with one or more instances of time and/or date information and aspects of the present intention may be described herein with reference to this record 10. However, it is to be understood that exemplary embodiments of the present invention are not limited to this particular record 10 or medical records in general. Exemplary embodiments of the present invention may be applicable to any unstructured text that may include one or more instances of time and/or date information. Moreover, “unstructured text,” as used herein, refers to text that is not structured with respect to time and/or date. Text that is otherwise structured may still be considered unstructured with respect to time and/or date.

Exemplary embodiments of the present invention may parse an unstructured text field and identity time and/or date information. Once identified, the time and/or date information may be interpreted in light of one or more known dates that may have been read from one or more structured fields, for example, structured fields that are part of the same record that includes the unstructured text field.

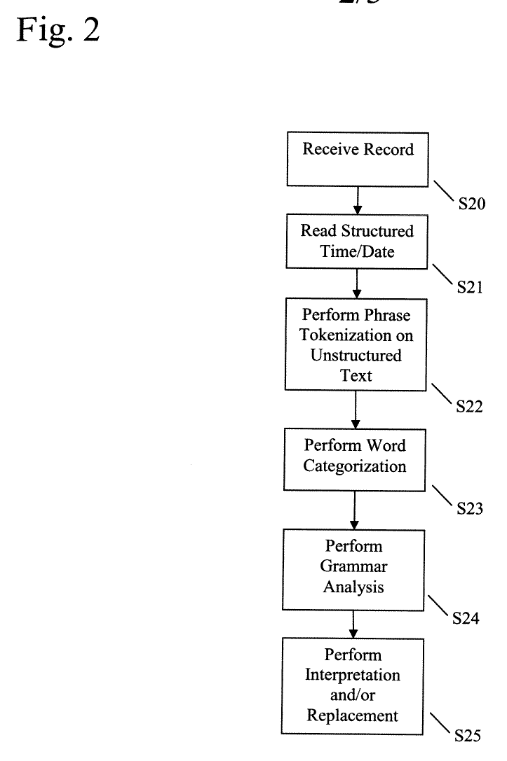

FIG. 2 is a flow chart showing a method for identification of unstructured text according to an exemplary embodiment of the present invention. First, a record may be received (Step S20). The record may include an unstructured text field and may optionally also include a structured time/date field. In this respect, the record illustrated in FIG. 1 may be a suitable record for exemplary purposes. Next, time/date information may be read from the structured field of the record (Step S21). This step may be omitted if there is no such field. The time/date information from the structured field may either be a manually entered time/date or an automatically generated time stamp that indicates the time/date that the record was created. The “Date of Examination” field of the exemplary record in FIG. 1 is an example of such a date that may have been manually entered. Time stamp information including the time and/or date that the record was created may also serve as the structured field. This information may be part of the metadata of the record rather than an actual record field.

The read structured time/date information may serve as a point of reference by which time and date information found within the unstructured data may be interpreted. This point is discussed in greater detail below.

Next, phrase tokenization may be performed on the unstructured text field (Step S22). Phrase tokenization is a process by which key words and phrases are identified within the unstructured text. These key words and phrases may be selected as likely to be used in referring to a time and/or date in natural language. Thus, in this step, each word and combination of closely occurring words of the unstructured text may be compared against a library of words or phrases known to be commonly used in expressing time and/or date. The library may be predetermined.

The library of time/date words/phrases may include, for example, actual units of time such as “second(s),” “minute(s),” “hour(s),” “day(s),” “week(s),” “month(s),” and “year(s)”. The library may also include other words that suggest a length of time or an actual point in time such as “Sunday,” “Monday,” (and other days of the week) “the first,” “the second,” (and other ordinals) “the holidays,” “New Years,” “Thanksgiving,” (and other holidays) “morning,” “afternoon,” “evening” (and other parts of the day) “spring,” “summer,” (and other seasons and portions of the year) “tomorrow,” (and other words that suggest a relative length of time) and any other possible word that could represent either an actual date, range of dates or time, or a length of time, either explicitly (such as “yesterday”) or implicitly (such as “moment”).

The library may also be extended with context-relevant words and phrases. For example, certain words and phrases that would not ordinarily represent times and dates in general may indicate a time and/or date in a certain context. For example, if the unstructured text relates to political content, the phrase “the Clinton administration” may represent a specific time. If the unstructured text relates to sports commentary, the phrase “Super Bowl XXXIX” may represent a specific time.

Thus the library may be a manually constructed set of words and phrases that are likely to be used as part of a description of a time and/or date, a “temporal” word or phrase.

Words and phrases that are found to match one or more of the words and phrases of the library during phrase tokenization are then categorized. In word categorization (Step S23), the matching words and phrases are placed into one of a set number of predetermined categories. Examples of categories include: month names, day names, numbers, ordinals, and adjectives. There may be significantly more predefined categories, as the more categories that are predefined, the more specialized the interpretation may be. Word categorization (Step S23) may either be performed separately from phrase tokenization (Step S22) or the two steps may be combined into a single step. When combined, the library of words and phrases may include class associations. When these steps are performed separately, the matching words and phrases may be matched against a second library of classes. Regardless of the manner of categorization, once an appropriate category has been determined, the category name or other identification may be annotated to the word or phrase, for example, as metadata.

After word categorization has been completed (Step S23), grammar analysis (step S24) may be performed. In grammar analysis (Step S24), the matching words or phrases may be compared against a set of rules to determine the particular phrase structure employed. By comparing a matching phrase to a particular phrase structure, the precise role of each word of the matching phrase may be determined.

The results of word categorization (Step S23) may be used to select the correct set of grammar rules. For example, each class of words or phrases may have one or more sets of grammar rules that may be applied to it. Thus, the step of word categorization (Step S23) may facilitate grammar analysis (Step S24).

Examples of grammar rules include: Exact Date, Partial Date, Relative Date, and Date Intervals, although many other grammar rules may be used. In Exact Date, date information extracted from the matching phrase represents a particular date in time. For example, the phrase, “Feb. 20, 2006” may be identified according to the Exact Date grammar rule.

In Partial Date, only a portion of the date information is provided and the remaining portion of the date may be implied. For example, “February 20^{th}” and “The 20^{th}”, are examples of information following Partial Date grammar. In the first case, both month and ordinal information is explicitly provided, while the year may be implied from either the time stamp information or based on a previous occurrence of date information, as implied by the context. Similarly, in the second case, only ordinal information is provided and both the month and year may be similarly determined. The omitted elements of the date information may be implied from syntactic clues such as the tense of the verb in the sentence that the temporal phrase appears. Thus a phrase such as, “the patient began the treatment on February 20^{th}” may be interpreted as the most recent February 20^{th} that has occurred in the past in relation to the time stamp date, while a phrase such as “the patient will continue treatment until February 20^{th}” may be interpreted as the next-occurring February 20^{th} in relation to the time stamp date.

In Relative Date, just as in Partial Date, the extracted date information is given meaning relative to an implied point of reference. However, unlike Partial Date, in Relative Date, no portion of the actual date is given explicitly. For example, the phrase “next week” or the word “yesterday” accords with Relative Date grammar. Each Relative Date phrase may be understood in terms of either the time stamp date or another date based on context.

In Date Intervals, the date information may express a range of time. This information may then be interpreted as a set of two specific dates, a start date and an end date. The time stamp date and/or synaptic clues may be used to interpret the date interval correctly where need be. For example, the phrase, “the patient should continue the course of treatment for the next two weeks” may be interpreted as a begin date equal to the time stamp date and an end date equal to the time stamp date plus 14 days.

In the next step, interpretation and/or replacement are performed (Step S25). Here, each unstructured reference to a time and/or date may either be replaced with a structured interpreted date or the structured interpreted date may be associated with the unstructured reference. For example, metadata indicating the structured interpreted date may be associated with the unstructured date.

After structured interpreted date information is associated with the unstructured text, the record may be more easily read and searched for. For example, medical research may be assisted by the ability to search through large numbers of patient files for a particular date-sensitive item, for example, those patients who have been taking a particular drug for more than two months.

To further describe the techniques discussed above, the application of the method of FIG. 2 to the record of FIG. 1 is explained in detail below. In Step S20, the medical record 10 is received by a computer system. The medical record 10 includes a time stamp/structured date field 12 and this field is read in Step S21. Accordingly, the date of Jan. 1, 2007 is recognized as the reference date. In Step S22, phrase tokenization is performed on the unstructured text field 13. In this step, the following phrases will be identified as temporal: “Nov. 2, 2006,” “November 4^{th}” “one week ago,” and “next two weeks.”

Then, in Step S23, word categorization is performed on the identified temporal phrases. In this step, “November” is characterized as a month name, “2,” “two,” “one,” and “2006” are characterized as numbers, “4^{th}” is characterized as an ordinal and “ago” and “next” are characterized as adjectives.

Then, grammar analysis may be performed at Step S24. The characterization of words from Step S23 allow for simplified grammar rule matching, for example, because “Nov. 2, 2006” has been characterized as “[month name] [number], [number]” it is understood to match with the exact date grammar rule. Similarly, because “November 4^{th}” has been characterized as “[month name] [ordinal]” it is understood to match with the partial date grammar rule. Because “one week ago” has been characterized as “[number] week [adjective]” it is understood to match the relative date grammar rule. Finally, because “next two weeks” has been characterized as “[adjective] [number] weeks” it is understood to match the date interval grammar rule.

It should be understood that each grammar rule may include multiple possible syntaxes and the syntaxes presented above are offered as examples. For example, the exact date grammar rule may have alternative syntaxes such as “[month name] [ordinal], [number]” or “[number] [month name] [number].”

By matching the temporal phrase to a grammar rule, the significance of each word may be more easily interpreted. Then, in Step S25, interpretation may be performed and the interpreted data may be associated with the temporal phrase from the unstructured text. In the instant example, “Nov. 2, 2006” matched to the exact date grammar rule with the syntax “[month name] [number], [number]” is interpreted to be Nov. 2, 2006, and this structured date information may then be associated with the temporal phrase.

Similarly, “November 4^{th}” matched to the partial date grammar rule with syntax “[month name] [ordinal]” is interpreted to be Nov. 2, 2006, with the year information calculated based on the past tense of the sentence including the temporal phrase and the realization that the most recently passed November 2002 as of Jan. 1, 2007, the header date from field 12, was Nov. 2, 2006.

The temporal phrase “one week ago” matched to the relative date grammar rule with syntax “[number] week [adjective]” is interpreted from the header date Jan. 1, 2007 to correspond to Dec. 25, 2006.

The temporal phrase “next two weeks” matched to the interval grammar rule with syntax “[adjective] [number] weeks” is interpreted from the header date Jan. 1, 2007 to correspond to the range of dates from Jan. 1, 2007 to Jan. 5, 2007.

The interpreted dates information may then be associated with the respective temporal phrases of the unstructured text field 13, for example by directly replacement or by insertion as metadata, information that may be searched on but is not displayed when displaying the record 10.

Accordingly, temporal phrases from unstructured text may be effectively interpreted to allow for easy retrieval of desired records from a query for particular date information.

It should be understood that while the example described above does not include time information, time information may be similarly interpreted using the same method. For example, phrase tokenization, word categorization, grammar analysis and interpretation may all be performed for time-of-day data.

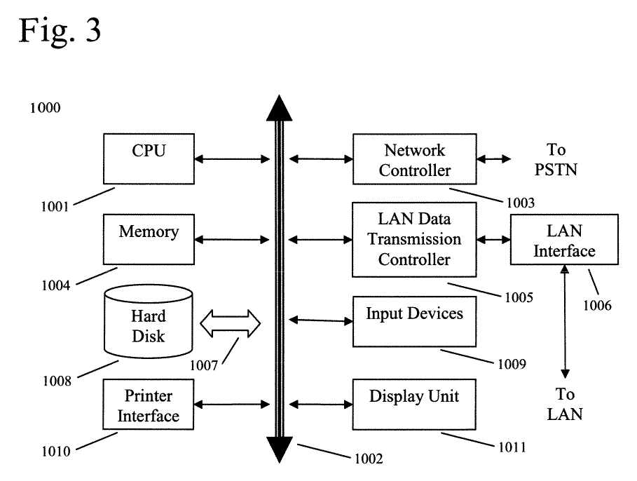

FIG. 3 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The above specific exemplary embodiments are illustrative, and many variations can be introduced on these embodiments without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for interpreting date information from unstructured text, comprising:
performing phrase tokenization on the unstructured text to identify one or more temporal phrases;
performing word categorization on the one or more temporal phrases to categorize one or more words of each temporal phrase;
performing grammar analysis to match each temporal phrase to an understood syntax using the categorizations of the words of each temporal phrase; and
interpreting each temporal phrase based on the matched syntax.

2. The method of claim 1, wherein interpreting each temporal phrase produces structured date information and the method additionally comprises associating the structured date information with the respective temporal phrase.

3. The method of claim 2, wherein the associated structured date information is saved to the unstructured text as metadata.

4. The method of claim 1, wherein interpretation of one or more temporal phrases is made with reference to structured date information.

5. The method of claim 4, wherein the structured date information is time stamp information.

6. The method of claim 1, wherein the structured date information is read from a first field of a database record and the unstructured text is included in a second field of the database record.

7. The method of claim 1, wherein performing phrase tokenization on the unstructured text to identify one or more temporal phrases includes comparing one or more words of the unstructured text to a library of words or phrases known to be commonly used in expressing date information.

8. The method of claim 7, wherein the library of words or phrases known to be commonly used in expressing date information includes context-relevant words or phrases.

9. The method of claim 1, wherein date information includes one or more of a year, month, week, day, hour, minute or second.

10. The method of claim 1, wherein performing word categorization on the one or more temporal phrases includes determining whether one or more words of the temporal phrases conforms to one or more of a set of predefined categories.

11. The method of claim 1, wherein in performing grammar analysis to match each temporal phrase to an understood syntax using the categorizations of the words of each temporal phrase, the matching of the words of each phrase includes comparing each phrase to a set of rules to determine the particular phrase structure employed.

12. A system for interpreting date information from unstructured text, comprising:
a database for storing one or more records having an unstructured text field including unstructured text;
a phrase tokenization unit for performing phrase tokenization on the unstructured text to identify one or more temporal phrases;
a word categorization unit for performing word categorization on the one or more temporal phrases to categorize one or more words of each temporal phrase; and
a grammar analysis unit for performing grammar analysis to match each temporal phrase to an understood syntax using the categorizations of the words of each temporal phrase.

13. The system of claim 12, additionally comprising an association unit for associating structured date information, produced by interpreting each temporal phrase, with the respective temporal phrase.

14. The system of claim 12, additionally comprising a structured date field within the record for storing structured date information, wherein interpretation of one or more temporal phrases is made with reference to structured date information.

15. The system of claim 14, wherein the structured date information is a time stamp.

16. A computer system comprising:
a processor; and
a program storage device readable by the computer system, embodying a program of instructions executable by the processor to perform method steps for interpreting date information from unstructured text, the method comprising:
receiving a record from a database, the record including an unstructured text field including the unstructured text;
performing phrase tokenization on the unstructured text to identify one or more temporal phrases;
performing word categorization on the one or more temporal phrases to categorize one or more words of each temporal phrase;
performing grammar analysis to match each temporal phrase to an understood syntax using the categorizations of the words of each temporal phrase;
interpreting each temporal phrase based on the matched syntax to produce structured date information; and
writing the structured date information to the database record.

17. The computer system of claim 16, wherein the associated structured date information is saved to the unstructured text as metadata.

18. The computer system of claim 16, wherein interpretation of one or more temporal phrases is made with reference to timestamp date information associated with the record.

19. The computer system of claim 16, wherein performing phrase tokenization on the unstructured text to identify one or more temporal phrases includes comparing one or more words of the unstructured text to a library of words or phrases known to be commonly used in expressing date information.

20. The computer system of claim 16, wherein in performing grammar analysis to match each temporal phrase to an understood syntax using the categorizations of the words of each temporal phrase, the matching of the words of each phrase includes comparing each phrase to a set of rules to determine the particular phrase structure employed.
